(19) United States
(12) Patent Application Publication
(10) Pub. No.: US 2026/0302334 A1
(43) Pub. Date: Oct. 1, 2026

(54) SOLID ELECTROLYTE SHEET, SOLID STATE BATTERY, AND METHOD OF MANUFACTURING SOLID STATE BATTERY

(71) Applicant: HONDA MOTOR CO., LTD., Tokyo (JP)

(72) Inventors: Takashi TOYOSHIMA, Saitama (JP); Akihiro YOSHIZAWA, Saitama (JP)

(21) Appl. No.: 19/571,497

(22) Filed: Mar. 19, 2026

(30) Foreign Application Priority Data
Mar. 28, 2025 (JP) 2025-054987

(51) Int. Cl. H01M 10/056; H01M 10/0525

(52) U.S. Cl. CPC H01M 10/056; H01M 10/0525; H01M 2300/0065; H01M 2300/0091

(57) ABSTRACT

To provide a solid electrolyte sheet in which cracks are unlikely to occur. The solid electrolyte sheet includes at least a solid electrolyte material and a dispersant, in which the critical strain is 0.5% or greater, and the arithmetic mean roughness Sa is 3.0 μm or less.

This application is based on and claims the benefit of priority from Japanese Patent Application No. 2025-054987, filed on 28 Mar. 2025, the content of which is incorporated herein by reference.

### BACKGROUND OF THE INVENTION

### Field of the Invention

The present invention relates to a solid electrolyte sheet, a solid state battery, and a method of manufacturing a solid state battery.

### Related Art

In recent years, research and development has been conducted on secondary batteries that contribute to improving energy efficiency, in order to enable a larger number of people to secure access to affordable, reliable, sustainable, and advanced energy.

As such secondary batteries, solid state batteries are known, such as lithium metal batteries and lithium-ion secondary batteries, in which a solid electrolyte layer is disposed between a positive electrode layer and a negative electrode layer. As an approach capable of preventing growth of Li dendrites in a solid electrolyte layer while minimizing a decrease in ionic conductivity in the solid electrolyte layer, Patent Document 1 discloses a technique of including, in the solid electrolyte layer, a binder having a Young's modulus equal to or less than a predetermined value.
Patent Document 1: PCT International Publication No. WO2021/250437

### SUMMARY OF THE INVENTION

Meanwhile, from viewpoints of reducing manufacturing cost and improving energy density, the solid electrolyte sheet (solid electrolyte layer) is preferably formed as a thin layer. However, when aggregates having a size equal to or greater than a predetermined size are present in the solid electrolyte sheet, cracks may occur in the solid electrolyte sheet starting from such portions, and the solid state battery may be short-circuited. Accordingly, the solid electrolyte sheet preferably does not include aggregates having a size equal to or greater than a predetermined size and is preferably unlikely to develop cracks.

The present invention has been made in view of the above circumstances, and an object of the present invention is to provide a solid electrolyte sheet in which cracks are unlikely to occur.

(1) The present invention relates to a solid electrolyte sheet including at least a solid electrolyte material and a dispersant, in which the solid electrolyte sheet has a critical strain of 0.5% or greater and an arithmetic mean roughness Sa of 3.0 μm or less.

(2) The solid electrolyte sheet according to (1), in which ionic conductivity is 0.3 mS/cm or greater.

(3) The solid electrolyte sheet according to (1) or (2), in which a critical current density is 1.5 mA/cm² or greater.

(4) The solid electrolyte sheet according to any one of (1) to (3), in which the arithmetic mean roughness Sa is 2.0 μm or less.

(5) The solid electrolyte sheet according to any one of (1) to (4), in which the solid electrolyte material includes at least one selected from the group consisting of a sulfide solid electrolyte material, an oxide solid electrolyte material, a halide solid electrolyte, a lithium-containing salt, and polyethylene oxide.

(6) The solid electrolyte sheet according to any one of (1) to (5), in which a particle diameter of the solid electrolyte material is between 0.1 μm and 10 μm inclusive.

(7) The solid electrolyte sheet according to any one of (1) to (6), in which a content of the solid electrolyte material in the solid electrolyte sheet is between 70 mass % and 99 mass % inclusive.

(8) The solid electrolyte sheet according to any one of (1) to (7), in which a content of the dispersant in the solid electrolyte sheet is 0.1 mass % or greater.

(9) The solid electrolyte sheet according to any one of (1) to (8), in which the dispersant includes an acrylic dispersant.

(10) The solid electrolyte sheet according to any one of (1) to (9), in which an average particle diameter D50 of aggregated particles contained in the solid electrolyte sheet is 10 μm or less.

(11) The solid electrolyte sheet according to any one of (1) to (10), in which a thickness of the solid electrolyte sheet is between 10 μm and 50 μm inclusive.

(12) The solid electrolyte sheet according to any one of (1) to (11), further including a binder.

(13) The solid electrolyte sheet according to (12), in which the binder includes a fluorine-based resin.

(14) The solid electrolyte sheet according to (12) or (13), in which the binder includes a fibrillated resin.

(15) The solid electrolyte sheet according to any one of (12) to (14), in which a weight-average molecular weight of the binder is between 100,000 and 2,500,000 inclusive.

(16) The solid electrolyte sheet according to any one of (12) to (15), in which the binder includes vinylidene fluoride, and a ratio of vinylidene fluoride in the binder is between 70 mol % and 85 mol % inclusive.

(17) The solid electrolyte sheet according to any one of (12) to (16), in which a content of the binder in the solid electrolyte sheet is between 1.0 volume % and 30 volumes inclusive.

(18) A solid state battery including the solid electrolyte sheet according to any one of (1) to (17).

(19) The solid state battery according to (18), including a positive electrode layer, a negative electrode layer, and an intermediate layer, in which elastic moduli of the positive electrode layer and the intermediate layer are between 0.5 times and 2.0 times inclusive of an elastic modulus of the solid electrolyte sheet.

(20) The solid state battery according to (18) or (19), in which the negative electrode layer includes lithium metal or a lithium alloy.

(21) A method of manufacturing the solid state battery according to any one of (18) to (20), the method including at least: a laminating step of laminating the solid electrolyte sheet and the intermediate layer to obtain a solid electrolyte sheet-intermediate layer laminate; a first pressing step of laminating and pressing the solid electrolyte sheet-intermediate layer laminate and the positive electrode layer to obtain an intermediate layer-solid electrolyte sheet-positive electrode layer laminate; and a second pressing step of laminating and pressing the intermediate layer-solid electrolyte sheet-positive electrode layer laminate and the negative electrode layer to integrate respective layers.

(22) A method of manufacturing the solid state battery according to any one of (18) to (20), the method including at least: a second laminating step of laminating the solid electrolyte sheet and the positive electrode layer to obtain a solid electrolyte sheet-positive electrode layer laminate; a third pressing step of laminating and pressing the solid electrolyte sheet-positive electrode layer laminate and the intermediate layer to obtain an intermediate layer-solid electrolyte sheet-positive electrode layer laminate; and a second pressing step of laminating and pressing the intermediate layer-solid electrolyte sheet-positive electrode layer laminate and the negative electrode layer to integrate respective layers.

(23) A method of manufacturing the solid state battery according to any one of (18) to (20), the method including at least: a fourth pressing step of laminating and pressing the intermediate layer, the solid electrolyte sheet, and the positive electrode layer to obtain an intermediate layer-solid electrolyte sheet-positive electrode layer laminate; and a second pressing step of laminating and pressing the intermediate layer-solid electrolyte sheet-positive electrode layer laminate and the negative electrode layer to integrate respective layers.

According to the present invention, it is possible to provide a solid electrolyte sheet in which cracks are unlikely to occur.

### BRIEF DESCRIPTION OF THE DRAWINGS

FIG. 1 is a diagram illustrating a solid state battery including a solid electrolyte sheet according to one embodiment of the present invention;

FIG. 2A is a diagram illustrating part of steps in a method of manufacturing a solid state battery according to one embodiment of the present invention;

FIG. 2B is a diagram illustrating part of steps in the method of manufacturing the solid state battery according to one embodiment of the present invention;

FIG. 2C is a diagram illustrating part of steps in the method of manufacturing the solid state battery according to one embodiment of the present invention;

FIG. 3 is a graph illustrating a relationship between binder content and critical strain for each type of binder included in the solid electrolyte sheet;

FIG. 4 is a graph illustrating a relationship between the binder content and ionic conductivity for each type of binder included in the solid electrolyte sheet;

FIG. 5 is a graph illustrating a relationship between binder content in the solid electrolyte sheet and ionic conductivity, and a relationship between D50 particle diameter and ionic conductivity;

FIG. 6 is a graph illustrating a relationship between the binder content in the solid electrolyte sheet and ionic conductivity, and a relationship between the D50 particle diameter and ionic conductivity;

FIG. 7 is a graph illustrating a relationship between the binder content and critical current density for each type of binder included in the solid electrolyte sheet;

FIG. 8 is a graph illustrating a relationship between a weight-average molecular weight of the binder included in the solid electrolyte sheet and ionic conductivity, and a relationship between the weight-average molecular weight of the binder included in the solid electrolyte sheet and critical strain;

FIG. 9 is a graph illustrating a relationship between a VDF ratio in the binder included in the solid electrolyte sheet and ionic conductivity, and a relationship between the VDF ratio in the binder included in the solid electrolyte sheet and critical strain;

FIG. 10 is a graph illustrating a relationship between the binder content included in the solid electrolyte sheet and ionic conductivity, and a relationship between the binder content included in the solid electrolyte sheet and critical strain;

FIG. 11 is a graph illustrating a relationship between the binder content included in the solid electrolyte sheet and ionic conductivity, and a relationship between the binder content included in the solid electrolyte sheet and critical current density;

FIG. 12 is a charge-discharge curve of the solid state battery;

FIG. 13 is a charge-discharge curve of the solid state battery;

FIG. 14 is a graph illustrating a relationship between an added amount of the dispersant in the solid electrolyte sheet and an arithmetic mean roughness Sa;

FIG. 15 is a graph illustrating a relationship between the added amount of the dispersant in the solid electrolyte sheet and a maximum height Sz;

FIG. 16 is a graph illustrating a relationship between the added amount of the dispersant in the solid electrolyte sheet and critical strain; and

FIG. 17 is a graph illustrating a relationship between the added amount of the dispersant in the solid electrolyte sheet and ionic conductivity, and a relationship between the added amount of the dispersant in the solid electrolyte sheet and density.

### DETAILED DESCRIPTION OF THE INVENTION

### [Solid Electrolyte Sheet]

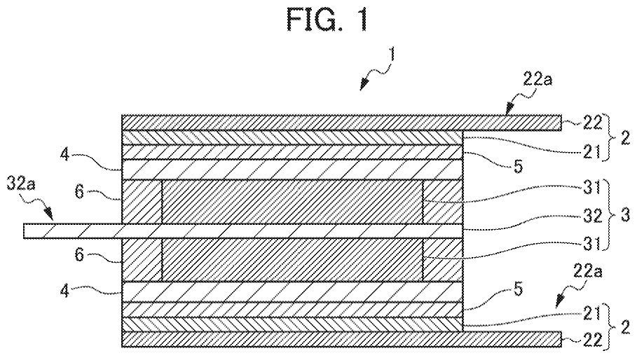

A solid electrolyte sheet 4 is used in a solid state battery 1 illustrated in FIG. 1. FIG. 1 is a diagram illustrating a laminated structure of the solid state battery 1. As illustrated in FIG. 1, the solid state battery 1 has a laminated structure, in which a negative electrode layer 2, an intermediate layer 5, and the solid electrolyte sheet 4 are laminated in this order. FIG. 1 illustrates one example of a solid state battery in which the solid electrolyte sheet 4 is used, and the configuration of the solid state battery is not limited to that illustrated in FIG. 1. The solid state battery may be a lithium-ion solid secondary battery or may be a lithium metal secondary battery.

In the present embodiment, the solid electrolyte sheet 4 is formed between the intermediate layer 5 and a positive electrode layer 3. In a case where the solid state battery 1 does not include the intermediate layer 5, the solid electrolyte sheet 4 may be formed between the negative electrode layer 2 and the positive electrode layer 3.

The solid electrolyte sheet 4 preferably has a critical strain of 0.5% or greater. Accordingly, preferable physical properties of the solid electrolyte sheet 4 can be achieved. Specifically, since the solid electrolyte sheet 4 can be stretched following other layers while maintaining a structure of the solid electrolyte sheet 4, occurrence of cracks in the solid electrolyte sheet 4 can be suppressed. By being pressed together with other layers, bonding properties with the other layers can be improved. For example, in consideration of pressing the solid electrolyte sheet 4 together with a layer thicker than the solid electrolyte sheet 4, such as the positive electrode layer 3, the critical strain of the solid electrolyte sheet 4 is more preferably 0.70% or greater, further preferably 0.80% or greater, and particularly preferably 1.0% or greater. An upper limit of the critical strain of the solid electrolyte sheet 4 is not particularly limited, and is, for example, 6.0% or less. The solid electrolyte sheet 4 may include a plurality of layers; however, since interfaces between a plurality of solid electrolyte sheets 4 may cause an increase in resistance and an increase in manufacturing cost, the solid electrolyte sheet 4 is preferably a single layer. In a case where the solid electrolyte sheet 4 includes a plurality of layers, a critical strain of at least one layer among the plurality of solid electrolyte sheets 4 is preferably 0.5% or greater.

In the present specification and claims, the term “critical strain” means a critical strain measured in a mandrel test. The mandrel test is performed by winding a sheet-shaped solid electrolyte layer densified so as to have a porosity of 4% or less around a circumference of a cylinder having a predetermined diameter, decreasing a diameter of the cylinder, and determining a diameter of the cylinder at which cracks occur. The critical strain is calculated by the following equation (1). Critical strain (%)=t/(D+t) (1).

In equation (1) above, t represents a thickness of the solid electrolyte layer, and D represents a diameter of the cylinder at which cracks occur.

The solid electrolyte sheet 4 preferably has an arithmetic mean roughness Sa of 3.0 μm or less. Accordingly, cracks caused by surface irregularities of the solid electrolyte sheet 4 are less likely to occur. The arithmetic mean roughness Sa of the solid electrolyte sheet 4 is more preferably 2.0 μm or less. A lower limit of the arithmetic mean roughness Sa of the solid electrolyte sheet 4 is not particularly limited, and is, for example, 0.1 μm or greater. The solid electrolyte sheet 4 preferably has a maximum height Sz of 40 μm or less. A lower limit of the maximum height Sz is not particularly limited, and is, for example, 0.01 μm or greater.

The solid electrolyte sheet 4 preferably has ionic conductivity of 0.3 mS/cm or greater. Accordingly, preferable chemical properties of the solid electrolyte sheet 4 can be achieved, and the resistance of the solid state battery 1 can be reduced. The ionic conductivity of the solid electrolyte sheet 4 is more preferably 0.5 mS/cm or greater.

The solid electrolyte sheet 4 preferably has a critical current density of 1.5 mA/cm² or greater. Accordingly, preferable chemical properties of the solid electrolyte sheet 4 can be achieved, and resistance to short-circuits due to dendrites growing with charging and discharging of the solid state battery 1 is improved. The critical current density of the solid electrolyte sheet 4 is more preferably 15 mA/cm² or greater.

The solid electrolyte sheet 4 includes at least a solid electrolyte material and a dispersant. The solid electrolyte sheet 4 preferably further includes a binder. The solid electrolyte material is not particularly limited, and examples thereof include inorganic solid electrolytes such as sulfide solid electrolyte materials, oxide solid electrolyte materials, halide solid electrolytes, and lithium-containing salts, and polymer-based solid electrolytes such as polyethylene oxide. The solid electrolyte materials described above may be used alone or in combination of two or more types.

The solid electrolyte material is preferably in a particulate form. A particle diameter (D50, median diameter) is preferably between 0.1 μm and 10 μm inclusive. Accordingly, the solid electrolyte sheet 4 can be densified, and generation of aggregates in the solid electrolyte sheet 4 is suppressed.

A content of the solid electrolyte material in the solid electrolyte sheet 4 is preferably between 70 mass % and 99 mass % inclusive.

As the binder included in the solid electrolyte sheet 4, a fluorine-based resin is preferably included. The binder is preferably fibrillated. Accordingly, preferable physical properties of the solid electrolyte sheet 4 can be achieved. Examples of such a binder include a binder including vinylidene fluoride (VDF). A ratio of vinylidene fluoride in the binder is preferably between 70 mol % and 85 mol % inclusive. The binder may include other types of binders in addition to the above-described binder. Examples of such binders include nitrile-based polymers, polyester-based polymers, acrylic acid-based polymers, cellulose-based polymers, styrene-based polymers, styrene-butadiene-based polymers, vinyl acetate-based polymers, and urethane-based polymers.

A content of the binder included in the solid electrolyte sheet 4 is preferably between 1.0 volume % and 30 volume % inclusive.

A weight-average molecular weight of the binder included in the solid electrolyte sheet 4 is preferably between 100,000 and 2,500,000 inclusive.

By increasing both the ratio of vinylidene fluoride in the binder included in the solid electrolyte sheet 4 and the weight-average molecular weight of the binder, toughness of the solid electrolyte sheet 4 can be improved. From this viewpoint, for example, the ratio of vinylidene fluoride is preferably 82% or greater, and the weight-average molecular weight is preferably 1,300,000 or greater.

Aggregated particles may be generated in the solid electrolyte sheet 4 due to aggregation of the solid electrolyte material, the binder, or the like. When aggregated particles are generated, the likelihood of crack occurrence in the solid electrolyte sheet 4 starting from such portions increases. In order to reduce such likelihood, an average particle diameter D50 of the aggregated particles is preferably 30 μm or less, and more preferably 10 μm or less. Alternatively, aggregated particles preferably have a size of 30 μm or less within an area of 100×100 mm in an image captured by a laser microscope. As the laser microscope described above, for example, a laser microscope VR-6000 (manufactured by Keyence Corporation) may be used, and an imaging magnification may be set to an equal magnification.

The solid electrolyte sheet 4 may include a dispersant for suppressing generation of the aggregated particles described above or for reducing a size of the aggregated particles. The dispersant is not particularly limited, provided that the dispersant does not react with the solid electrolyte material and can preferably disperse the solid electrolyte material. Examples of the dispersant include an acrylic dispersant. The acrylic dispersant has a (meth)acryloyl group in a molecule thereof.

A content of the dispersant in the solid electrolyte sheet 4 is preferably between 0.1 mass % and 1.0 mass % inclusive. When the content of the dispersant is 0.2 mass % or greater, an effect of suppressing aggregated particles can be preferably achieved. Even when the content of the dispersant exceeds 1.0 mass %, an effect commensurate with an added amount cannot be achieved. By setting the content of the dispersant to 0.2 mass % or less, an energy density of the solid state battery 1 can be improved.

The solid electrolyte sheet 4 is preferably formed as only one layer between the intermediate layer 5 and the positive electrode layer 3, or between the negative electrode layer 2 and the positive electrode layer 3, in the solid state battery 1. A thickness of the solid electrolyte sheet 4 in a lamination direction is preferably between 10 μm and 50 μm inclusive. Accordingly, a manufacturing cost of the solid state battery 1 can be reduced, and preferable physical properties of the solid electrolyte sheet 4 can be achieved. The thickness of the solid electrolyte sheet 4 in the lamination direction is more preferably between 10 μm and 30 μm inclusive.

### [Negative Electrode Layer]

The negative electrode layer 2 includes a negative electrode active material layer 21 and a negative electrode current collector layer 22. The negative electrode active material layer 21 is not particularly limited, and may be formed of a material that can be used as a negative electrode active material for a solid state battery. The negative electrode active material layer 21 is preferably a lithium metal layer in which a negative electrode active material is lithium metal or a lithium alloy. In the solid state battery 1 according to the present embodiment, the solid electrolyte sheet has a critical strain of 0.5% or greater. Accordingly, even when the negative electrode active material layer 21 is a lithium metal layer or a lithium alloy layer, cracks in the negative electrode active material layer 21 can be suppressed when the negative electrode active material layer 21 and the solid electrolyte sheet are laminated, and during expansion and contraction of the negative electrode layer 2 during charging and discharging. A metal that can be alloyed with lithium to form the lithium metal alloy described above is not particularly limited, and examples thereof include one or more metals selected from the group consisting of Sn, Ag, Mg, In, Si, Al, Bi, Sb, Zn, and Cu. In addition to the above, the negative electrode active material layer 21 may be formed of a silicon-based active material such as Si or a Si alloy, a lithium transition metal oxide such as lithium titanate (Li₄Ti₅O₁₂), a transition metal oxide such as TiO₂, Nb₂O₃, or WO3, a metal sulfide, a metal nitride, a carbon material such as graphite, soft carbon, or hard carbon, metallic indium, or the like.

The negative electrode active material layer 21 may further include materials that can be contained in a negative electrode active material layer of a solid state battery, in addition to the materials described above. Examples of such materials include a solid electrolyte, a conductive additive, and a binder. Examples of the conductive additive include carbon black, natural graphite, carbon fibers, and carbon nanotubes. Examples of the solid electrolyte and the binder include materials similar to the solid electrolyte material included in the solid electrolyte sheet 4 described above.

The negative electrode current collector layer 22 is not particularly limited, and may be formed of copper, nickel, stainless steel, or the like. Examples of the shape of the negative electrode current collector layer 22 include a foil shape, a plate shape, a mesh shape, a nonwoven fabric shape, and a porous shape. A portion of the negative electrode current collector layer 22 extends in a predetermined direction to form a negative electrode current collector tab 22a.

### [Positive Electrode Layer]

The positive electrode layer 3 includes a positive electrode active material layer 31 and a positive electrode current collector layer 32. In the present embodiment, the positive electrode layer 3 has a configuration in which two positive electrode active material layers 31 are laminated on both surfaces of one positive electrode current collector layer 32. However, the configuration of the positive electrode layer 3 is not limited to the above, and the positive electrode layer 3 may have a configuration in which one positive electrode active material layer 31 is laminated on one surface of one positive electrode current collector layer 32.

The positive electrode active material layer 31 is not particularly limited, and may be formed of a material that can be used as a positive electrode active material for a solid state battery. Examples of a positive electrode active material forming the positive electrode active material layer 31 include: layered positive electrode active material particles such as LiCoO₂, LiNiO₂, LiCoₓNi_{y}Mn_{z}O₂ (x+y+z=1), LiVO₂, and LiCrO₂; spinel-type positive electrode active materials such as LiMn₂O₄, Li(Ni_{0.25}Mn_{0.75})₂O₄, LiCoMnO₄, and Li₂NiMn₃O₈; olivine-type positive electrode active materials such as LiCoPO₄, LiMnPO₄, and LiFePO₄; solid-solution oxides such as Li₂MnO₃-LiMO₂ (M=Co, Ni, or the like); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The positive electrode active material described above may be used alone, or may be a combination of two or more of the materials described above.

An insulating frame 6 may be provided at an outer peripheral portion of the positive electrode active material layer 31. The insulating frame 6 can prevent a short-circuit of the solid state battery 1 and can improve strength. In the present embodiment, the insulating frame 6 is disposed so as to cover side surfaces of the two positive electrode active material layers 31 formed on both surfaces of the positive electrode current collector layer 32. The insulating frame 6 is in contact with a part of a lamination surface of the positive electrode current collector layer 32, and has a gap through which a positive electrode current collector tab 32a described below extends. A material forming the insulating frame 6 is not particularly limited, and examples thereof include insulating oxides such as alumina, resins such as polyvinylidene fluoride (PVDF), and rubbers such as styrene-butadiene rubber (SBR).

The positive electrode current collector layer 32 is not particularly limited, and may be formed of, for example, aluminum, stainless steel, conductive carbon (graphite, carbon nanotubes, or the like), or the like. Examples of the shape of the positive electrode current collector layer 32 include a foil shape, a plate shape, a mesh shape, a nonwoven fabric shape, and a porous shape. A portion of the positive electrode current collector layer 32 extends in a predetermined direction to form a positive electrode current collector tab 32a.

### [Intermediate Layer]

The intermediate layer 5 is disposed between the negative electrode layer 2 and the solid electrolyte sheet 4. For example, in a case where the solid state battery 1 is a lithium metal battery, the intermediate layer 5 has a function of uniformly depositing lithium metal. Accordingly, an interface between the intermediate layer 5 and the solid electrolyte sheet 4 is stabilized. In a case where the solid state battery 1 is a lithium metal secondary battery including the intermediate layer 5, the solid state battery 1 may be an anode-free battery in which the negative electrode active material layer 21 is not present at an initial stage. In this case, after initial charging and discharging, a lithium metal layer as the negative electrode active material layer 21 is formed. The number of intermediate layers 5 is not particularly limited.

A material forming the intermediate layer 5 is not particularly limited, and examples thereof include a metal capable of alloying with lithium, and amorphous carbon. Examples of the metal capable of alloying with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). These metals may be composited with carbon. The metal capable of alloying with lithium may be in a nanoparticle form. Examples of the amorphous carbon include carbon blacks such as acetylene black, furnace black, and Ketjen black, coke, and activated carbon. The amorphous carbon may be graphitizable carbon (soft carbon), non-graphitizable carbon (hard carbon), CNT (carbon nanotubes), fullerene, or graphene. The intermediate layer 5 may further include a binder in addition to the materials described above. As the binder, a material similar to a binder that can be included in the solid electrolyte sheet 4 can be used.

In the solid state battery 1, elastic moduli of the positive electrode layer and the intermediate layer are preferably between 0.5 times and 2.0 times inclusive of an elastic modulus of the solid electrolyte sheet 4. Accordingly, in a manufacturing process of the solid state battery, when the positive electrode layer and/or the intermediate layer and the solid electrolyte sheet are pressed and bonded (integrated), compression and elongation behaviors of the positive electrode layer and the intermediate layer become similar, thereby reducing a possibility of damage to respective layers. From this viewpoint, the elastic moduli of the positive electrode layer and the intermediate layer are more preferably between 0.9 times and 1.1 times inclusive of the elastic modulus of the solid electrolyte sheet 4.

### [Method of Manufacturing Solid State Battery]

### First Embodiment

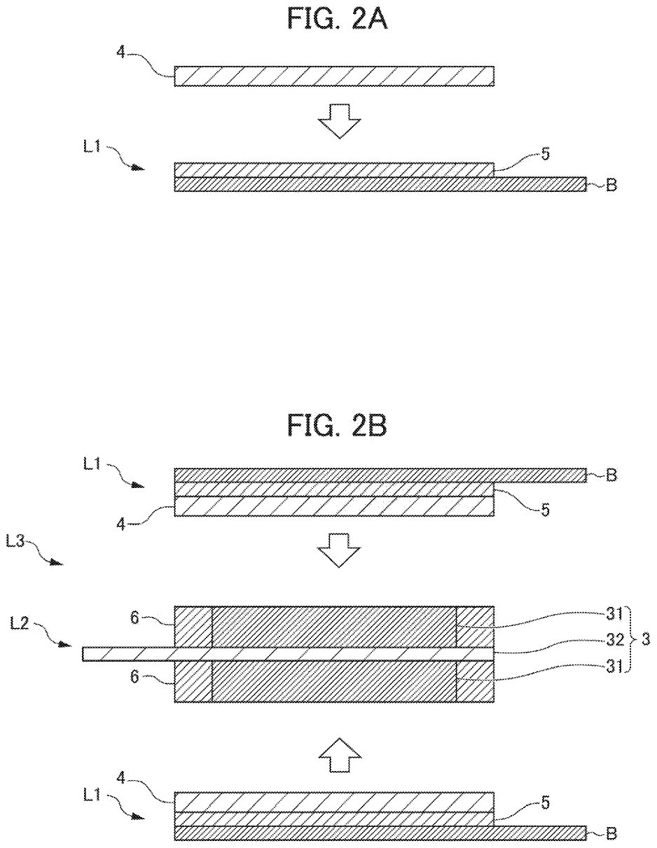

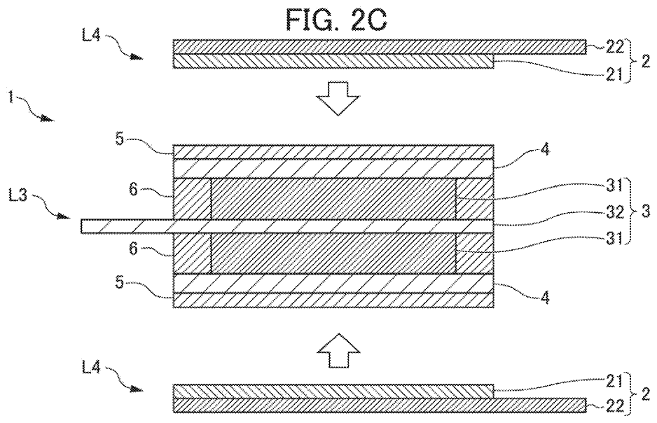

A method of manufacturing a solid state battery according to the present embodiment will be described below with reference to FIGS. 2A to 2C. The method of manufacturing the solid state battery according to the present embodiment is a method of manufacturing a solid state battery 1 having an electrode laminate in which a negative electrode layer 2, an intermediate layer 5, a solid electrolyte sheet 4, and a positive electrode layer 3 are laminated in this order. The method of manufacturing the solid state battery according to the present embodiment includes at least: a first laminating step of laminating the solid electrolyte sheet 4 and the intermediate layer 5 to obtain a solid electrolyte sheet-intermediate layer laminate L1; a first pressing step of laminating and pressing the solid electrolyte sheet-intermediate layer laminate L1 and the positive electrode layer 3 to obtain an intermediate layer-solid electrolyte sheet-positive electrode layer laminate L3; and a second pressing step of laminating and pressing the intermediate layer-solid electrolyte sheet-positive electrode layer laminate L3 and the negative electrode layer 2 to integrate respective layers. The first laminating step, the first pressing step, and the second pressing step are executed in this order.

As illustrated in FIG. 2A, the first laminating step includes laminating the solid electrolyte sheet 4 and the intermediate layer 5 to obtain the solid electrolyte sheet-intermediate layer laminate L1. Examples of a method of laminating the solid electrolyte sheet 4 and the intermediate layer 5 include a method in which a slurry obtained by dispersing a material forming the intermediate layer 5 in a solvent is applied onto a substrate B and dried, and thereafter the solid electrolyte sheet 4 is disposed on the intermediate layer 5. Examples of a method of disposing the solid electrolyte sheet 4 on the intermediate layer 5 include a method in which a slurry obtained by dispersing a material forming the solid electrolyte sheet 4 in a solvent is applied onto the intermediate layer 5 and dried. Alternatively, a method may be used in which the slurry described above is applied onto a support sheet and dried to form the solid electrolyte sheet 4, and the solid electrolyte sheet 4 is transferred onto the intermediate layer 5. Alternatively, a method may be used in which the solid electrolyte sheet 4 formed in advance into a sheet shape is disposed on the intermediate layer 5. After disposing the solid electrolyte sheet 4 on the intermediate layer 5, respective layers may be pressed.

As illustrated in FIG. 2B, the first pressing step includes laminating and pressing the solid electrolyte sheet-intermediate layer laminate L1 and the positive electrode layer 3 to obtain the intermediate layer-solid electrolyte sheet-positive electrode layer laminate L3. In the present embodiment, the positive electrode layer 3 has positive electrode active material layers 31 formed on both surfaces of the positive electrode current collector layer 32, and the solid electrolyte sheet-intermediate layer laminate L1 is disposed on both positive electrode active material layers 31.

A pressing pressure in the first pressing step is preferably, for example, 100 MPa or greater and 1200 MPa or less. A temperature during pressing in the first pressing step is preferably, for example, 25° C. or higher and 120° C. or lower.

As illustrated in FIG. 2C, the second pressing step includes laminating and pressing the intermediate layer-solid electrolyte sheet-positive electrode layer laminate L3 and the negative electrode layer 2 to obtain the solid state battery 1 (laminate). In the present embodiment, the negative electrode layer 2 is disposed on both intermediate layers 5 of the intermediate layer-solid electrolyte sheet-positive electrode layer laminate L3.

A pressing pressure in the second pressing step is preferably, for example, 1 MPa or greater and 1200 MPa or less. A temperature during pressing in the second pressing step is preferably, for example, 25° C. or higher and 120° C. or lower.

### Second Embodiment

Hereinafter, a method of manufacturing a solid state battery according to another embodiment of the present invention will be described. Descriptions of contents similar to those of the first embodiment described above may be omitted.

The method of manufacturing the solid state battery according to the present embodiment includes at least: a second laminating step of laminating the solid electrolyte sheet 4 and the positive electrode layer 3 to obtain a solid electrolyte sheet-positive electrode layer laminate; a third pressing step of laminating and pressing the solid electrolyte sheet-positive electrode layer laminate and the intermediate layer 5 to obtain an intermediate layer-solid electrolyte sheet-positive electrode layer laminate; and a second pressing step of laminating and pressing the intermediate layer-solid electrolyte sheet-positive electrode layer laminate and the negative electrode layer 2 to integrate respective layers. The second laminating step, the third pressing step, and the second pressing step are executed in this order.

The method of manufacturing the solid state battery according to the second embodiment differs from the first embodiment in that, instead of the first laminating step of laminating the solid electrolyte sheet 4 and the intermediate layer 5, the second laminating step of laminating the solid electrolyte sheet 4 and the positive electrode layer 3 is provided. The method further differs from the first embodiment in that, instead of the first pressing step of laminating and pressing the solid electrolyte sheet-intermediate layer laminate L1 and the positive electrode layer 3, the third pressing step of laminating and pressing the solid electrolyte sheet-positive electrode layer laminate and the intermediate layer 5 is provided. An order in which respective layers are laminated is the same as that in the first embodiment.

A pressing pressure in the third pressing step of the second embodiment is preferably, for example, 100 MPa or greater and 1200 MPa or less. A temperature during pressing in the third pressing step is preferably, for example, 25° C. or higher and 120° C. or lower.

A pressing pressure in the second pressing step of the second embodiment is preferably, for example, 1 MPa or greater and 1200 MPa or less. A temperature during pressing in the second pressing step is preferably, for example, 25° C. or higher and 120° C. or lower.

### Third Embodiment

The method of manufacturing a solid state battery according to the present embodiment includes at least: a fourth pressing step of laminating and pressing the intermediate layer 5, the solid electrolyte sheet 4, and the positive electrode layer 3 to obtain an intermediate layer-solid electrolyte sheet-positive electrode layer laminate; and a second pressing step of laminating and pressing the intermediate layer-solid electrolyte sheet-positive electrode layer laminate and the negative electrode layer 2 to integrate respective layers.

The method of manufacturing the solid state battery according to the third embodiment differs from the first embodiment in that, instead of the first laminating step and the first pressing step, the fourth pressing step is provided in which respective layers are laminated and pressed simultaneously. An order in which respective layers are laminated is the same as that in the first embodiment.

A pressing pressure in the fourth pressing step of the third embodiment is preferably, for example, 100 MPa or greater and 1200 MPa or less. A temperature during pressing in the fourth pressing step is preferably, for example, 25° C. or higher and 120° C. or lower.

A pressing pressure in the second pressing step of the third embodiment is preferably, for example, 1 MPa or greater and 1200 MPa or less. A temperature during pressing in the second pressing step is preferably, for example, 25° C. or higher and 120° C. or lower.

Hereinafter, the present invention will be described in more detail by way of Examples. The present invention is not limited to contents of the following Examples.

### Examples

### [Relationship Between Binder Content and Critical Strain]

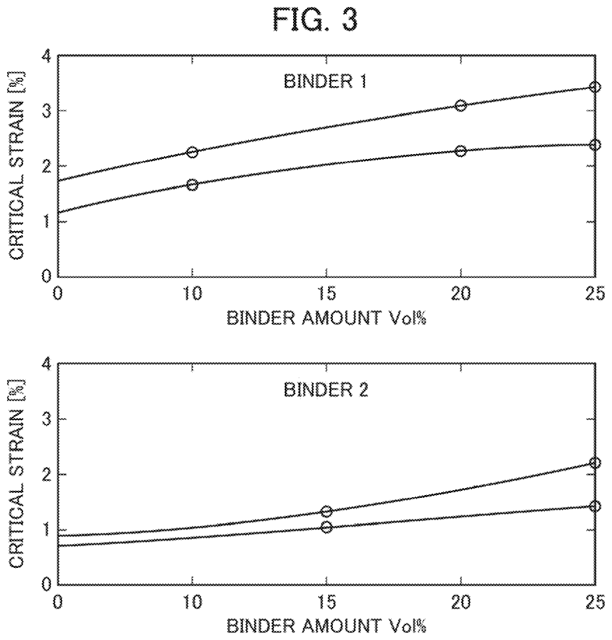

Solid electrolyte sheets were prepared in which a fluorine-based binder (vinylidene fluoride-based resin) as Binder 1 and a styrene-butadiene-based resin as Binder 2 were each contained at predetermined contents. By varying the binder content, a critical strain of each solid electrolyte sheet was measured. The critical strain was measured and calculated by the method described in the above embodiments. Measurements were performed twice, and respective results are illustrated in FIG. 3. In FIG. 3, a vertical axis represents the critical strain (%), and a horizontal axis represents the binder content (volume %).

As illustrated in FIG. 3, it was confirmed that, by including a vinylidene fluoride-based resin as the binder in the solid electrolyte sheet, the critical strain of the solid electrolyte sheet can be easily adjusted to a preferable range.

### [Relationship Between Binder Content and Ionic Conductivity]

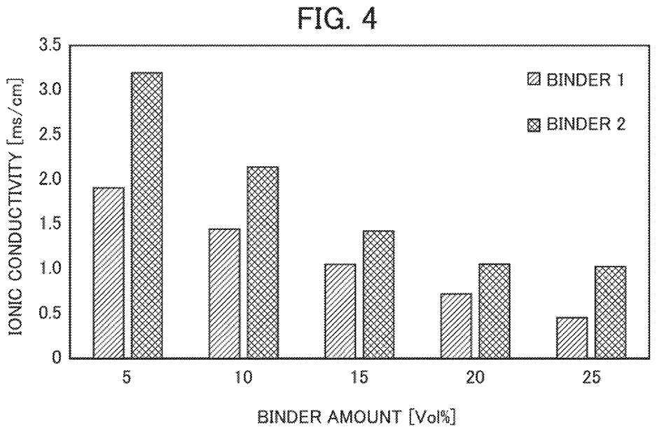

Solid electrolyte sheets were prepared in which a vinylidene fluoride-based resin as Binder 1 and a styrene-butadiene-based resin as Binder 2 were each contained at predetermined contents. By varying the binder content, ionic conductivity of each solid electrolyte sheet was measured. The ionic conductivity was measured by an AC impedance method. Results are illustrated in FIG. 4.

As illustrated in FIG. 4, it was confirmed that, in both a case where the solid electrolyte sheet includes a vinylidene fluoride-based resin as the binder and a case where the solid electrolyte sheet includes a styrene-butadiene-based resin, ionic conductivity can be easily adjusted to a preferable range.

### [Relationship Among Binder Content, Ionic Conductivity, and Particle Diameter]

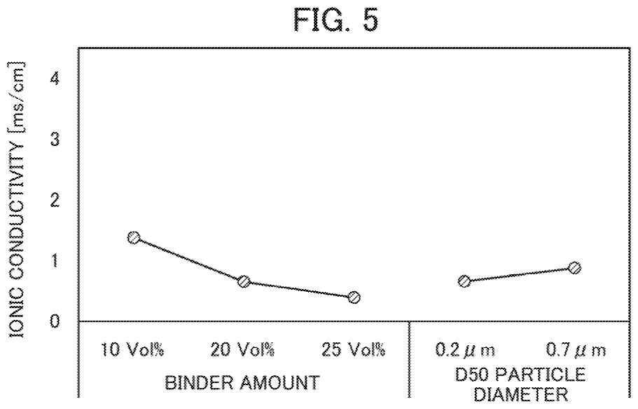

Solid electrolyte sheets were prepared in which a vinylidene fluoride-based resin was contained as the binder at predetermined contents. In addition, ionic conductivity was measured for cases in which the binder content was set to 17.5 volume % and a particle diameter (D50) of the solid electrolyte materials was set to 0.2 μm and 0.7 μm, respectively. The ionic conductivity was measured by an AC impedance method. Results are illustrated in FIG. 5.

As illustrated in FIG. 5, it was confirmed that, in both cases where the particle diameter (D50) of the solid electrolyte material was 0.2 μm and 0.7 μm, ionic conductivity can be easily adjusted to a preferable range.

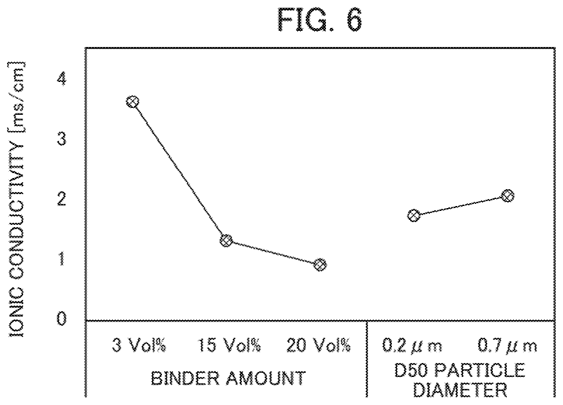

Solid electrolyte sheets were prepared in which a vinylidene fluoride-based resin was contained as the binder at predetermined contents. In addition, ionic conductivity was measured for cases in which the binder content was set to 17.5 volume % and the particle diameter (D50) of the solid electrolyte materials was set to 0.2 μm and 0.7 μm, respectively. The ionic conductivity was measured by an AC impedance method. Results are illustrated in FIG. 6.

As illustrated in FIG. 6, it was confirmed that, in both cases where the particle diameter (D50) of the solid electrolyte material was 0.2 μm and 0.7 μm, ionic conductivity can be easily adjusted to a preferable range.

### [Relationship Between Binder Content and Critical Current Density]

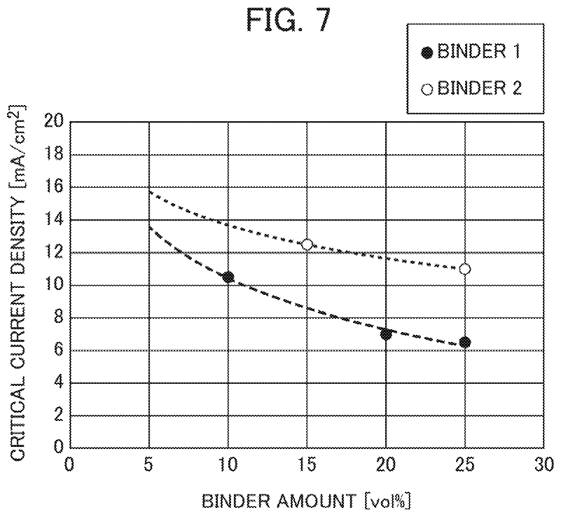

Solid electrolyte sheets were prepared in which a vinylidene fluoride-based resin as Binder 1 and a styrene-butadiene-based resin as Binder 2 were each contained at predetermined contents. By varying the binder content, a critical current density of each solid electrolyte sheet was measured. The critical current density was obtained by applying a current at different charge-discharge rates and measuring a voltage increase at that time. Results are illustrated in FIG. 7.

As illustrated in FIG. 7, it was confirmed that, in both a case where the solid electrolyte sheet includes a vinylidene fluoride-based resin as the binder and a case where the solid electrolyte sheet includes a styrene-butadiene-based resin, the ionic conductivity can be easily adjusted to a preferable range.

[Relationship of Weight-Average Molecular Weight and VDF Ratio of Binder with Ionic Conductivity and Critical Strain]

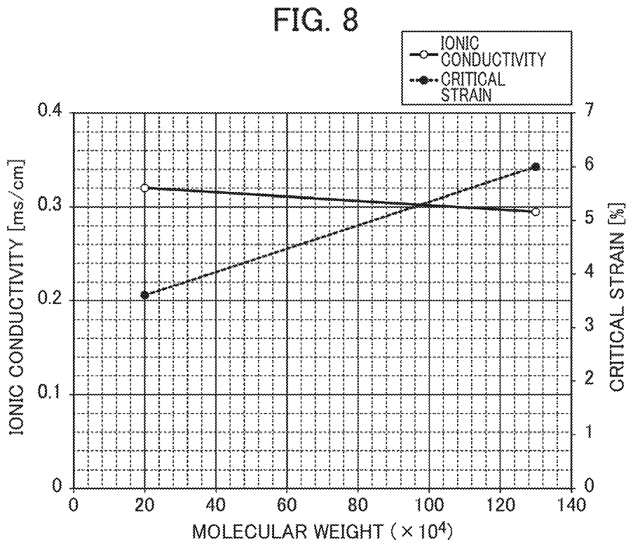

Using a binder a having a weight-average molecular weight of 200,000 and a binder b having a weight-average molecular weight of 1,250,000, electrolyte sheets were prepared, and ionic conductivity and critical strain were measured. Results are illustrated in FIG. 8. In the graph of FIG. 8, a left vertical axis represents ionic conductivity (mS/cm), and a right vertical axis represents critical strain (%). A horizontal axis represents a weight-average molecular weight (×10⁴) of each binder.

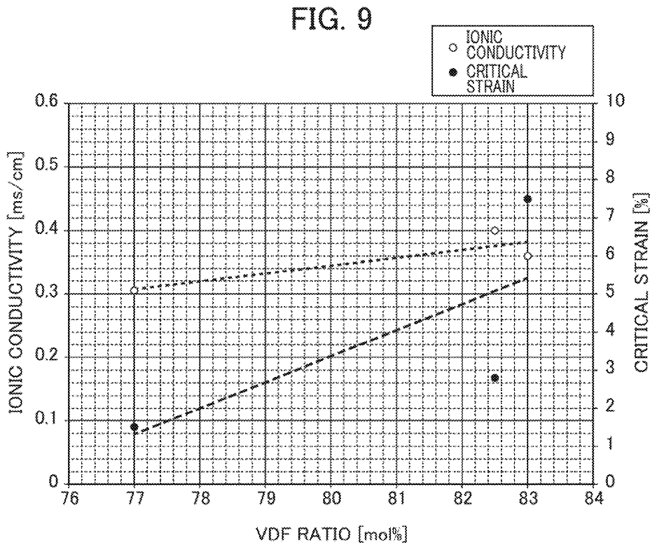

Using a binder c having a VDF ratio of 78 mol %, a binder f having a VDF ratio of 82 molo, and a binder d having a VDF ratio of 83 mol %, electrolyte sheets were prepared, and ionic conductivity and critical strain were measured. Results are illustrated in FIG. 9. In the graph of FIG. 9, a left vertical axis represents ionic conductivity (mS/cm), and a right vertical axis represents critical strain (%). A horizontal axis represents a VDF ratio (mol %) of each binder.

As illustrated in FIGS. 8 and 9, it was confirmed that, by setting the weight-average molecular weight of the binder to a predetermined weight-average molecular weight, or by setting the VDF ratio to between 70 mol % and 85 mol % inclusive, a preferable ionic conductivity and a preferable critical strain can be achieved concurrently.

[Relationship of Binder Content with Ionic Conductivity and Critical Strain]

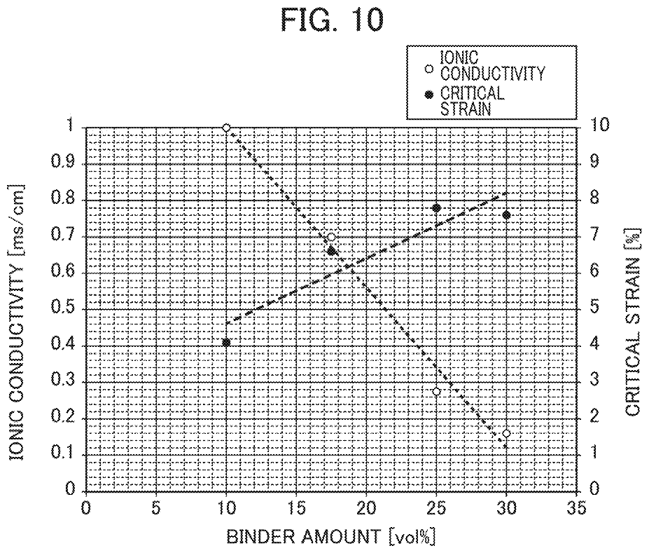

Electrolyte sheets having different binder contents were prepared with a binder having a weight-average molecular weight of 200,000 and a VDF ratio of 82 mol %, and ionic conductivity and critical strain were measured. Results are illustrated in FIG. 10. In the graph of FIG. 10, a left vertical axis represents ionic conductivity (mS/cm), and a right vertical axis represents critical strain (%). A horizontal axis represents a binder content (volume %) of each binder.

As illustrated in FIG. 10, it was confirmed that, by setting the binder content to between 1.0 volumes and 30 volume % inclusive, a preferable ionic conductivity and a preferable critical strain can be achieved concurrently.

[Relationship of Binder Content with Ionic Conductivity and Critical Current Density]

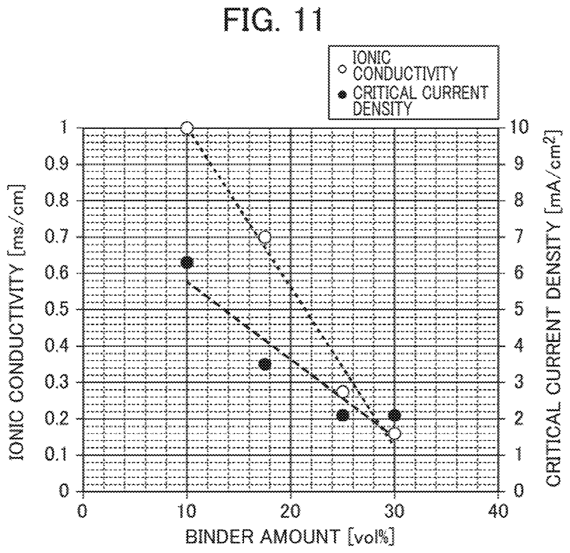

Electrolyte sheets having different binder contents were prepared with a binder having a weight-average molecular weight of 200,000 and a VDF ratio of 82 mol %, and ionic conductivity and critical current density were measured. Results are illustrated in FIG. 11. In the graph of FIG. 11, a left vertical axis represents ionic conductivity (mS/cm), and a right vertical axis represents critical current density (C-rate). A horizontal axis represents a binder content (volume %) of each binder.

As illustrated in FIG. 11, it was confirmed that, by setting the binder content to between 1.0 volumes and 30 volume % inclusive, a preferable ionic conductivity and a preferable critical current density can be achieved concurrently.

### [Charge-Discharge Test]

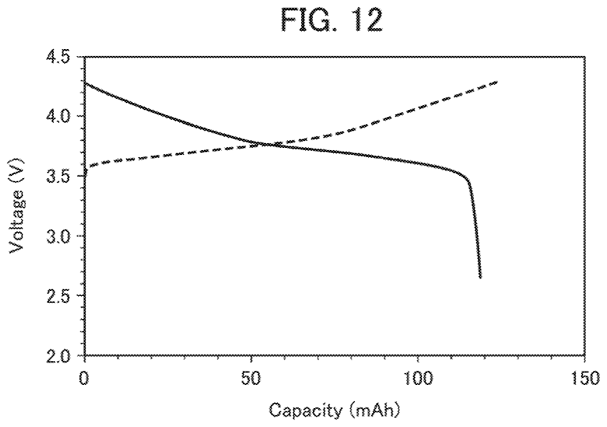

Solid state batteries were fabricated by the method illustrated in FIGS. 2A to 2C. As a positive electrode active material, 60 mass % of nickel-manganese-cobalt oxide (NMC622) was used. As a negative electrode active material, lithium metal was used. As an intermediate layer, Sn—C (a composite material of Sn and C) or Ag—C (a composite material of Ag and C) was used. A content of the binder included in the solid electrolyte sheet was set to 10 volumes, a VDF ratio was set to 80 molo, and a weight-average molecular weight was set to 1,300,000. A thickness of the solid electrolyte sheet was set to 34 μm (single layer). Pressing conditions in the first pressing step were set to a pressing pressure of 800 MPa and a temperature of 25° C. Pressing conditions in the second pressing step were set to a pressing pressure of 150 MPa and a temperature of 60° C. A charge-discharge test was performed using the solid state batteries fabricated as described above. Results are illustrated in FIG. 12.

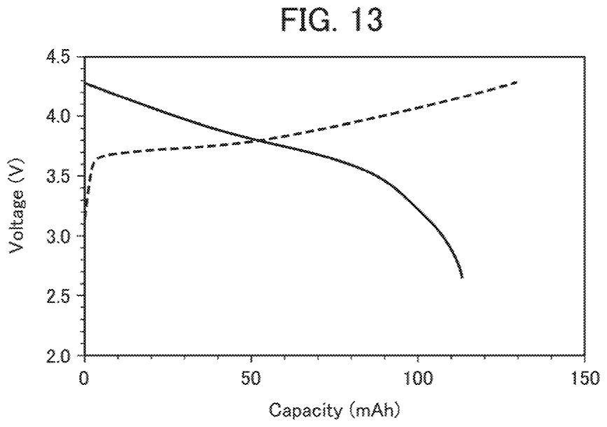

A charge-discharge test was performed using solid state batteries fabricated under the same conditions as those of FIG. 12, except that the thickness of the solid electrolyte sheet was set to 17 μm (single layer). Results are illustrated in FIG. 13.

As illustrated in FIGS. 12 and 13, it was confirmed that, by using a solid electrolyte sheet fabricated under predetermined conditions, a predetermined reached voltage and charge-discharge efficiency can be achieved.

### [Relationship Between Amount of Dispersant Added and Aggregated Particles]

Solid electrolyte sheets were prepared using 77.75 mass % of a sulfide-based solid electrolyte as a solid electrolyte material, a fluorine-based binder (vinylidene fluoride-based resin) as a binder, and different contents of a dispersant (acrylic dispersant). For the prepared solid electrolyte sheets, the number of aggregated particles per unit area (cm²), an arithmetic mean roughness Sa and a maximum height Sz (μm), a peel strength test, a critical strain, and ionic conductivity were measured.

TABLE 1

| Binder ratio (mass %) | | | 22.25 | 22.15 | 22.05 | 21.95 | 21.75 | 21.25 |
|---|---|---|---|---|---|---|---|---|
| Dispersant ratio (mass %) | | | 0 | 0.1 | 0.2 | 0.3 | 0.5 | 1 |
| Evaluation | Evaluation | Unit | | | | | | |
| | method | | | | | | | |
| Aggregate | Image | | 100% | 82% | 87% | 84% | 68% | 80% |
| amount | analysis | | | | | | | |
| Surface | Laser | Sa/Sz (μm) | 2.7/70 | 1.9/43 | 1.7/40 | 1.7/41 | 1.7/39 | 1.9/41 |
| roughness | microscope | | | | | | | |
| Peel | 180° peel | N/m | 83 | 88 | 95 | 88 | 88 | 90 |
| strength | test | | | | | | | |
| Critical | Mandrel test | % | 6 | 6 | 6 | 6 | 6 | 6 |
| strain | | | | | | | | |
| Ionic | Base cell | mS/cm | 0.39 | 0.49 | 0.58 | 0.57 | 0.59 | 0.55 |
| conductivity | | | | | | | | |

### [Aggregate Amount Test]

Image analysis was performed using a laser microscope VR-6000 (manufactured by Keyence Corporation), and the number of aggregated particles per unit area (pieces/cm²) of each solid electrolyte sheet was determined. Specifically, shadows (defective portions) having a density equal to or greater than a predetermined value with respect to a white general portion (sound portion) were detected as aggregated particles, and the number of aggregated particles (pieces/cm²) was determined. A ratio of the number of aggregated particles (aggregate amount) was calculated in each case, assuming that the number of aggregated particles (pieces/cm²) in a case where a dispersant ratio was 0% was 100%. Results are illustrated in Table 1. As illustrated in Table 1, it was confirmed that the number of aggregated particles decreases by setting a content of the dispersant in the solid electrolyte sheet to 0.1 mass % or greater.

### [Surface Roughness Test]

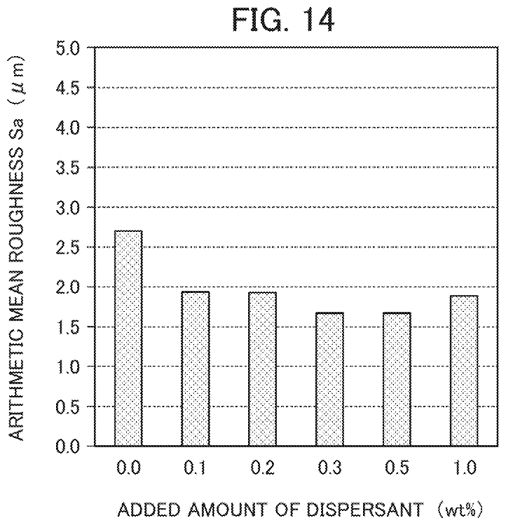

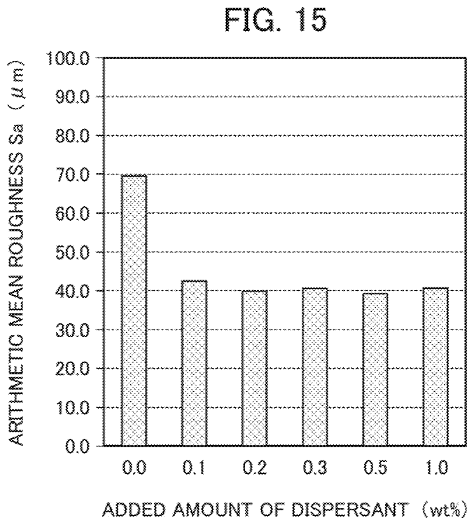

An arithmetic mean roughness Sa and a maximum height Sz of each solid electrolyte sheet were measured using unevenness measurement values obtained by a laser microscope. Results are illustrated in Table 1 and FIGS. 14 and 15. As illustrated in Table 1 and FIGS. 14 and 15, it was confirmed that, by setting the content of the dispersant to 0.1 mass % or greater, the arithmetic mean roughness Sa and the maximum height Sz of the solid electrolyte sheet are reduced, and surface properties are stabilized.

### [Peel Strength Test]

Each solid electrolyte sheet was formed on an Al metal foil with a film thickness of approximately 65 μm, and a 180° peel test was performed using a peel tester. Peel conditions were set such that a width of a test piece was 25 mm and a peel rate was 100 mm/min. Results are illustrated in Table 1. As illustrated in Table 1, it was confirmed that an added amount of the dispersant has little influence on peel strength.

### [Critical Strain Test]

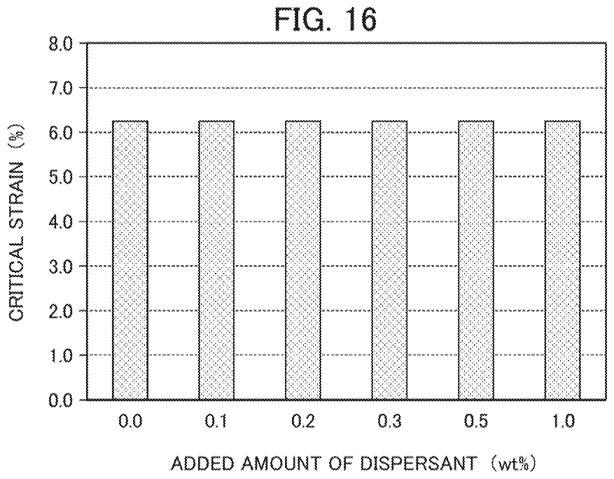

Test pieces were coated with a coating gap of 200 μm for each solid electrolyte sheet, and a critical strain of each solid electrolyte sheet was measured by the mandrel test described above. Results are illustrated in Table 1 and FIG. 16. As illustrated in Table 1 and FIG. 16, it was confirmed that an added amount of the dispersant has little influence on critical strain.

### [Ionic Conductivity Test]

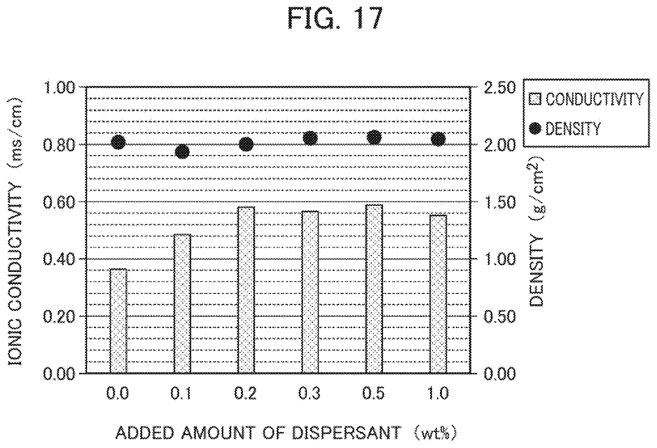

Each solid electrolyte sheet was densified with a pressing pressure of 980 MPa, and ionic conductivity was measured by an AC impedance method under a confining pressure of 3 MPa. Results are illustrated in Table 1 and FIG. 17. In the graph of FIG. 17, a left vertical axis represents ionic conductivity (mS/cm), and a right vertical axis represents a density of the solid electrolyte sheet (g/cm²). As illustrated in Table 1 and FIG. 17, it was confirmed that a preferable ionic conductivity can be achieved by setting the content of the dispersant in the solid electrolyte sheet to 0.1 mass % or greater.

### EXPLANATION OF REFERENCE NUMERALS

1: solid state battery
2: negative electrode layer
3: positive electrode layer
4: solid electrolyte sheet
5: intermediate layer

What is claimed is:

1. A solid electrolyte sheet, comprising at least a solid electrolyte material and a dispersant,
wherein a critical strain is 0.5% or greater, and
an arithmetic mean roughness Sa is 3.0 μm or less.

2. The solid electrolyte sheet according to claim 1, wherein ionic conductivity is 0.3 mS/cm or greater.

3. The solid electrolyte sheet according to claim 1, wherein a critical current density is 1.5 mA/cm² or greater.

4. The solid electrolyte sheet according to claim 1, wherein the arithmetic mean roughness Sa is 2.0 μm or less.

5. The solid electrolyte sheet according to claim 1, wherein the solid electrolyte material comprises at least one selected from the group consisting of a sulfide solid electrolyte material, an oxide solid electrolyte material, a halide solid electrolyte, a lithium-containing salt, and polyethylene oxide.

6. The solid electrolyte sheet according to claim 1, wherein a particle diameter of the solid electrolyte material is between 0.1 μm and 10 μm inclusive.

7. The solid electrolyte sheet according to claim 1, wherein a content of the solid electrolyte material in the solid electrolyte sheet is between 70 mass % and 99 mass % inclusive.

8. The solid electrolyte sheet according to claim 1, wherein a content of the dispersant in the solid electrolyte sheet is 0.1 mass % or greater.

9. The solid electrolyte sheet according to claim 1, wherein the dispersant comprises an acrylic dispersant.

10. The solid electrolyte sheet according to claim 1,
wherein aggregated particles are comprised in the solid electrolyte sheet, and
an average particle diameter D50 of the aggregated particles is 10 μm or less.

11. The solid electrolyte sheet according to claim 1, wherein a thickness of the solid electrolyte sheet is between 10 μm and 50 μm inclusive.

12. The solid electrolyte sheet according to claim 1, further comprising a binder.

13. The solid electrolyte sheet according to claim 12, wherein the binder comprises a fluorine-based resin.

14. The solid electrolyte sheet according to claim 12, wherein the binder comprises a fibrillated resin.

15. The solid electrolyte sheet according to claim 12, wherein a weight-average molecular weight of the binder is between 100,000 and 2,500,000 inclusive.

16. The solid electrolyte sheet according to claim 12,
wherein the binder comprises vinylidene fluoride, and
a ratio of vinylidene fluoride in the binder is between 70 mol % and 85 mol % inclusive.

17. The solid electrolyte sheet according to claim 12, wherein a content of the binder in the solid electrolyte sheet is between 1.0 volume % and 30 volumes inclusive.

18. A solid state battery, comprising the solid electrolyte sheet according to claim 1.

19. The solid state battery according to claim 18, further comprising a positive electrode layer, a negative electrode layer, and an intermediate layer,
wherein elastic moduli of the positive electrode layer and the intermediate layer are between 0.5 times and 2.0 times inclusive of an elastic modulus of the solid electrolyte sheet.

20. The solid state battery according to claim 19, wherein the negative electrode layer comprises lithium metal or a lithium alloy.
